(19) United States
(12) Patent Application Publication
(10) Pub. No.: US 2013/0132628 A1
(43) Pub. Date: May 23, 2013

(54) PLUG-IN MODULE, ELECTRONIC SYSTEM, AND JUDGING METHOD AND QUERYING METHOD THEREOF

(71) Applicants: Yan-Chang LI, Shanghai (CN); Chi-Lung Tsai, New Taipei City (TW)

(72) Inventors: Yan-Chang LI, Shanghai (CN); Chi-Lung Tsai, New Taipei City (TW)

(73) Assignee: Universal Scientific Industrial (Shanghai) Co.,Ltd, Shanghai (CN)

(21) Appl. No.: 13/488,637

(22) Filed: Jun. 5, 2012

(30) Foreign Application Priority Data
Nov. 18, 2011 (CN) 201110370400.8

(51) Int. Cl. G06F 13/00

(52) U.S. Cl. 710/300

(57) ABSTRACT

The present invention relates to a plug-in module is capable of being inserted in a slot of a motherboard pluggably. The plug-in module includes an addressable element which has a slave address. The addressable element includes an interface address line group and a device-type address line group. When the plug-in module is inserted into the slot of the motherboard, the slot is able to automatically assign a corresponding interface address to the addressable element via the interface address line group. The device type address line group is integrated with a device-type identification code to identify a device type of the plug-in module. The slave address includes the interface address and the device-type identification code. Moreover, the present invention also relates to an electronic system, and a corresponding judging method and a corresponding querying method thereof.

### TECHNICAL FIELD

The disclosure generally relates to a plug-in module, an electronic system, and a corresponding judging method and a corresponding querying method thereof, and more particularly to a plug-in module which can provide a device-type identification code and obtain an interface address automatically assigned by a slot, a corresponding electronic system using the plug-in module, and a corresponding judging method and a corresponding querying method thereof.

### BACKGROUND

With the progress of times, the electronic technology has been developed quickly. At present, some electronic systems, such as controlling and/or communicating systems generally include a plurality of plug-in modules with different types. Furthermore, addressable elements, for example I²C elements, are generally integrated on these plug-in modules respectively. These plug-in modules are inserted into slots of a motherboard respectively, so as to achieve a variety of functions in a single electronic system.

FIG. 1 is a schematic view of a conventional electronic system. Referring to FIG. 1, the electronic system 100 includes a motherboard 110, and a plurality of plug-in modules 120. The motherboard 110 includes a plurality of slots, such as slots 0˜4, such that the plug-in modules 120 are able to be inserted into the slots 0˜4 respectively. Each plug-in module 120 includes an addressable element 121, such as an I²C element, respectively. Those plug-in modules 120 inserted into the slots 0˜2 are plug-in modules with a same type (e.g., type A), and are different from the type of the plug-in module 120 (e.g., type B) inserted into the slot 3 and the type of the plug-in module 120 (e.g., type C) inserted into the slot 4.

After the plug-in modules 120 are inserted into the motherboard 110 respectively, only when a CPU set on the motherboard 110 is able to determine the slave address of the addressable element 121 of each of the plug-in modules 120 inserted into the slots 0˜4 respectively, the CPU can access a plug-in module 120 inserted into a specific slot. That is, the CPU need perform an addressing operation for the plug-in modules 120 inserted into the slots 0˜4, respectively.

FIG. 2 is a schematic view of an addressable element as shown in FIG. 1. Referring to FIG. 2, the addressable element 121 includes a plurality of address lines A0˜A2 which are stably connected to different pull-up resistors or pull-down resistors (not shown), respectively, to enable each plug-in module 120 to have a unique slave address. Therefore, the addressable element 121 thereof is integrated with the slave address which cannot be changed when each plug-in module 120 is produced. That is static addressing mode.

Referring to FIG. 1 and FIG. 2 together, although both of two plug-in modules 120 inserted into the slot 0 and the slot 1 are the modules with the same type (type A), under the conventional static addressing mode, due to the addressable elements 121 of the two plug-in modules 120 were integrated with two different slave addresses respectively, and the plug-in modules 120 inserted into the slot 0 and the slot 1 cannot be arbitrarily replaced with each other. For example, if it needs to insert the plug-in module A-2 into the slot 0, which is originally inserted into the slot 1, it must modify the function of the software for accessing the slot 0, to make the above function correspond to the address of the addressable element of the plug-in module A-2. Thus, the plug-in module A-2 can be accessed via the slot 0. Therefore, the conventional static addressing mode will lead to the interoperability and maintainability of the plug-in modules 120 with the same type greatly weakened, and not convenient in use.

In addition, in the conventional electronic system 100, when the plug-in modules 120 are inserted into the slots 0˜4 of the motherboard 110, respectively, it generally requires the motherboard 110 capable of detecting whether the types of the plug-in modules 120 inserted into the slots 0˜4 respectively are correct. If the types of the inserted plug-in modules 120 are not correct, the CPU (not shown) set on the motherboard 110 cannot access the plug-in modules 120, therefore, the plug-in modules 120 need to provide their device-type identification codes respectively, to identify the device types of the plug-in modules 120.

At present, in order to make each plug-in module 120 to provide it's device-type identification code, in a conventional technology, each plug-in module 120 is added an extra piece of EEPROM which stores a corresponding device-type identification code thereof. So that, the CPU can read the EEPROM of each plug-in module 120 to determine the device type of each plug-in module 120. However, the conventional technology needs to add an extra EEPROM, which inevitably increases the hardware cost thereof.

In another conventional technology, each plug-in module 120 may further include a plurality of pins (not show), and the pins are integrated with the logic high level, or the logic low levels, respectively, to provide the device-type identification code thereof to identify the device type of each plug-in module 120. However, these pins need to be electrically coupled to different general purpose input/output (GPIO) pins of the CPU. Assuming each plug-in module 120 further includes two pins to provide its device-type identification code, for the electronic system 100 as shown in FIG. 1, it requires the CPU further provides ten GPIO pins thereof to be coupled to these plug-in modules 120, which undoubtedly occupies precious hardware resources of the CPU, and brings great difficulties for the hardware design of the motherboard 110.

### SUMMARY OF EMBODIMENTS

Accordingly, the present disclosure relates to a plug-in module, an electronic system and a judging method and a querying method thereof, which can solve the above problems of the prior art, and enhance the interoperability and maintainability thereof, reduce the cost, and avoid occupying a lot of resources of a CPU.

The present disclosure relates to a plug-in module, which is capable of being inserted in a slot of a motherboard pluggably. The plug-in module includes an addressable element which has a slave device address. The addressable element includes an interface address line group and a device-type address line group. When the plug-in module is inserted into the slot of the motherboard, the slot is able to automatically assign a corresponding interface address to the addressable element via the interface address line group. The device type address line group is integrated with a device-type identification code to identify a device type of the plug-in module. The slave device address includes the interface address and the device-type identification code.

The present disclosure also relates to an electronic system, which includes a motherboard and at least one plug-in module. The motherboard includes at least one slot. The at least one plug-in module is capable of being pluggably inserted into the at least one slot of the motherboard respectively. Each plug-in module includes an addressable element which has a slave device address. The addressable element includes an interface address line group and a device type address line group. When this plug-in module is inserted into one slot of the motherboard, the slot is able to automatically assign a corresponding interface address to the addressable element via the interface address line group. The device-type address line group is integrated with device-type identification code to identify a device type of the plug-in module. The slave device address includes the interface address and the device-type identification code.

Preferably, the interface address line group of the addressable element comprises at least one address line and the slot of the motherboard comprises at least one gold finger pin. Each gold finger pin is electrically coupled to a pull-up resistor, or a pull-down resistor, or is set to be in floating ground, respectively, to produce a logic high level, a logic low level, or a logical floating ground level, so as to identify the interface address of the slot. When the plug-in module is inserted into the slot of the motherboard, the at least one address line of the interface address line group of the addressable element is electrically coupled to the at least one gold finger pin of the slot, respectively, and thereby the slot is able to automatically assign the interface address to the addressable element via the interface address line group.

Preferably, the device-type address line group of the addressable element comprises at least one address line. Each address line is electrically coupled to a pull-up resistor, or a pull-down resistor, or is set to be in floating ground, respectively, to produce a logic high level, a logic low level, or a logic floating ground level, thereby, the device type address line group is integrated with the device-type identification code to identify the device type of the plug-in module.

Preferably, the addressable element further comprises a transmission bus for outputting the slave address.

Preferably, the addressable element is an I²C addressable element, and the transmission bus is an I²C bus.

The present disclosure further relates to a judging method, which is adapted to an electronic system for judging whether a correct plug-in module is inserted into a specific slot of a motherboard of the electronic system. The judging method includes step S11: issuing an access request to a plug-in module inserted into the specific slot according to an ideal slave address corresponding to the specific slot by a CPU set on the motherboard, wherein the ideal slave address comprises an interface address corresponding to the specific slot, and a device-type identification code of the correct plug-in module which should be inserted into the specific slot; and Step S12: detecting whether the CPU receives a response; wherein if the CPU receives the response, the plug-in module inserted into the specific slot is the correct plug-in module which should be inserted into the specific slot; on the contrary, the plug-in module inserted into the specific slot is not the correct plug-in module which should be inserted into the specific slot.

Preferably, when a device-type identification code of a slave address comprised in an addressable element of the plug-in module is same to the device-type identification code of the ideal slave address of the correct plug-in module which should be inserted into the slot, the plug-in module responds the access request, and the CPU receives the response.

Preferably, the CPU issues the access request to the plug-in module via a transmission bus, and the CPU receives the response via the transmission bus.

The plug-in module and the electronic system of the present disclosure can use the addressable element of each of the plug-in module to define the slave address thereof. The slave address includes the interface address and the device-type identification code. In particular, when one plug-in module is inserted into one slot of the motherboard, the slot can automatically assign the corresponding interface address to the addressable element of the plug-in module via the interface address line group, therefore the interface address obtained by the addressable element always corresponds to the slot which the plug-in module is inserted into. The present disclosure can optionally change the plug-in module with the same type in the same slot, need not change the function of the software for accessing the slot, therefore the present disclosure greatly enhances interoperability and maintainability of the plug-in module with the same type, extremely convenient to use.

Furthermore, the plug-in module of the present disclosure may use the address lines of the addressable element to integrate the device-type identification code, thus indentifying the device type of the plug-in module, such that the plug-in module need not set the extra EEPROM to store the device-type identification code thereof, and also need not set special pins to integrate the device-type identification code, thus the present disclosure can reduce the hardware cost, and won't greatly occupy the resource of the GPIO pins of the CPU.

Other embodiments of the disclosure will be further understood from the further technological features disclosed by the embodiments of the present disclosure wherein there are shown and described preferred embodiments, simply by way of illustration of modes best suited to carry out the disclosure.

### BRIEF DESCRIPTION OF THE DRAWINGS

The various embodiments disclosed herein will be better understood with respect to the following description and drawings, in which like numbers refer to like parts throughout, and in which:

FIG. 1 is a schematic view of a conventional electronic system;

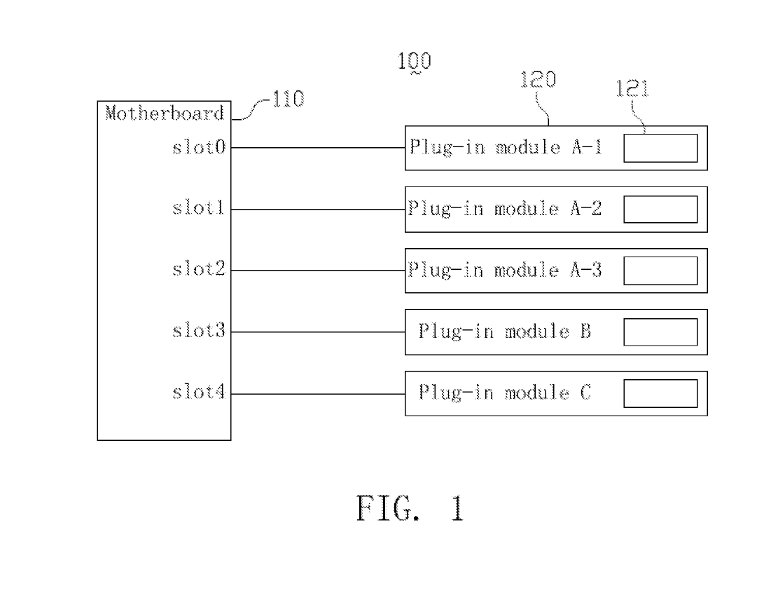

FIG. 2 is a schematic view of the addressable element in FIG. 1;

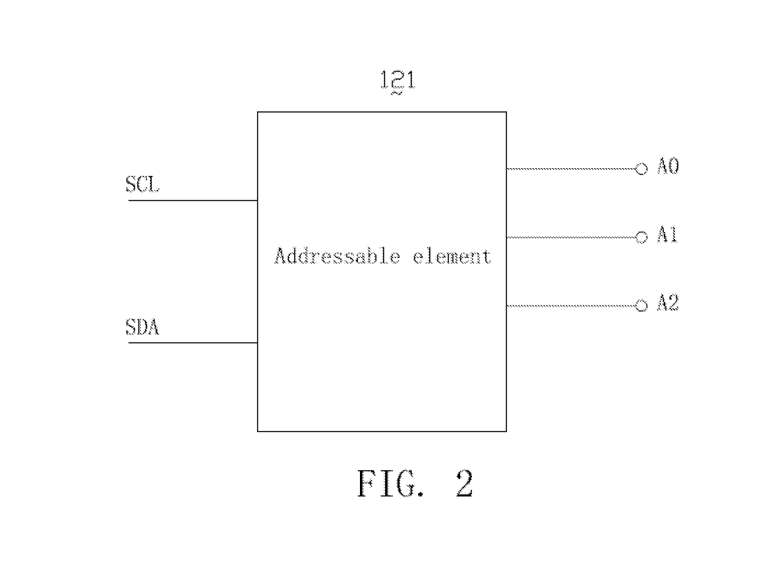

FIG. 3 is a schematic view of an electronic system in accordance with an exemplary embodiment of the present disclosure;

FIG. 4 is a flowchart of a judging method adapted to the electronic system in accordance with an exemplary embodiment;

FIG. 5 is a flowchart of a querying method adapted to the electronic system in accordance with an exemplary embodiment; and

FIG. 6 is a schematic view of application of the electronic system in FIG. 3.

### DETAILED DESCRIPTION

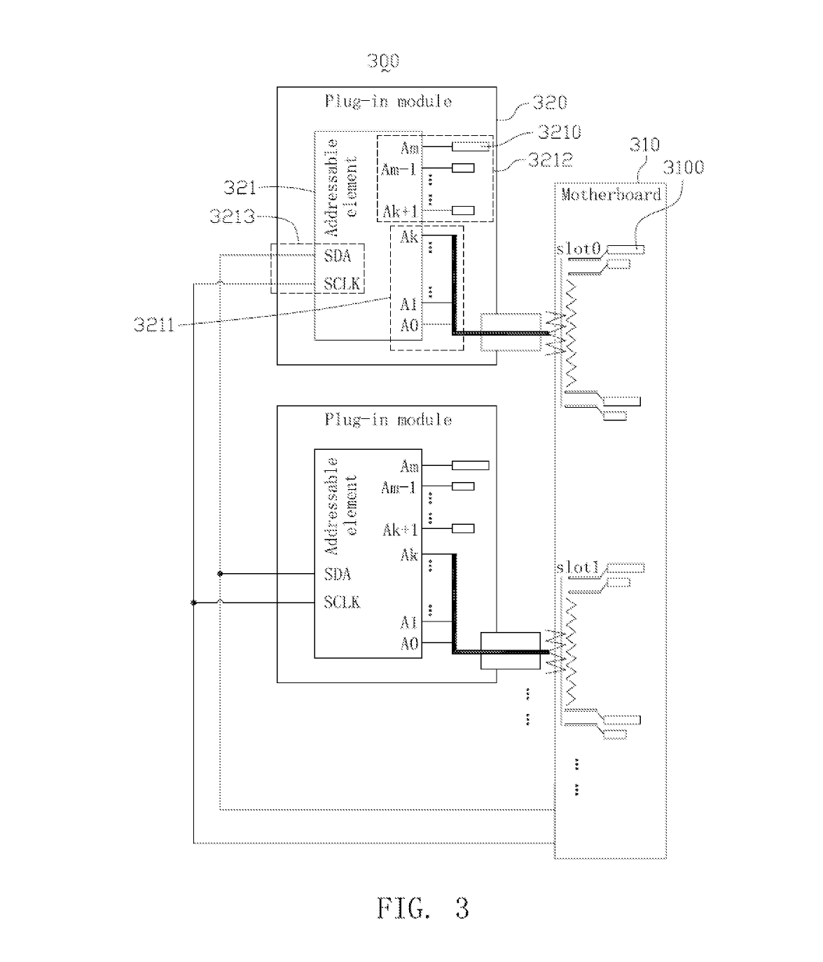

FIG. 3 is a schematic view of an electronic system in accordance with an exemplary embodiment of the present disclosure. Referring to FIG. 3, the electronic system 300 includes a motherboard 310, and a plurality of plug-in modules 320. The motherboard 310 includes a plurality of slots, such as slots 0˜n, such that the plug-in modules 320 are able to be pluggably inserted thereinto, respectively. Each plug-in module 320 includes an addressable element 321, respectively, for example, an I²C addressable element. The addressable element 321 may be a temperature sensor or a pressure sensor, and so on, and is for sensing temperature or pressure. The present disclosure mainly uses original address lines of the addressable element 321 to define a slave address thereof. The slave address includes an interface address SlotID and a device-type identification code CardID.

The addressable element 321 of each plug-in module 320, includes a plurality of address lines A0˜Am. Some address lines, such as low address lines A0˜Ak, are grouped as an interface address line group 3211. When the plug-in module 320 is inserted into one slot of the motherboard 310, the slot can automatically assign the interface address SlotID, which corresponds to the slot, to the addressable element 321 via the interface address line group 3211. While other address lines, such as high address lines A(k+1)˜Am, are grouped as a device-type address line group 3212, and are integrated with a device-type identification code CardID to identify the device type of the plug-in module 320.

Each of the high address lines A(k+1)˜Am of the device-type address line group 3212 of the addressable element 321 of each plug-in module 320 is electrically coupled to a pull-up resistor or a pull-down resistor 3210, respectively, to obtain the logic high level or the logic low level, respectively, thereby, in the production of the plug-in module 320, the device-type identification code CardID is integrated in the device-type address line group 3212 of the addressable element 321, to identify the device type of this plug-in module 320.

Each of the slots 0˜n of the motherboard 310 includes a plurality of gold finger pins respectively. Each of the gold finger pins is electrically coupled to a pull-up resistor or a pull-down resistor 3100 respectively, to obtain the logic high level or the logic low level respectively, thereby uniquely identifying an interface address of this slot. When one plug-in module 320 is inserted into one slot (e.g., the slot [i]), these low address lines A0˜Ak of the interface address line group 3211 of the addressable element 321 of the plug-in module 320 are electrically coupled to these gold finger pins of the slot [i], respectively, thereby automatically obtaining the interface address of the slot [i] according to the pull-up resistor or the pull-down resistor 3100 electrically coupled to each of the gold finger pins. That is, when the plug-in module 320 is inserted into the slot [i], the slot [i] can automatically assign the interface address SlotID [i] to the addressable element 321 of the plug-in module 320 via the interface address line group 3211.

Therefore, when the motherboard 310 is produced, each of the slots 0˜n is uniquely integrated with the interface address SlotID. When one plug-in module 320 is inserted into any one slot, the slot can automatically assign the corresponding interface address SlotID to the addressable element 321 of the plug-in module 320 inserted into the slot.

In addition, the addressable element 321 of each plug-in module 320 further includes a transmission bus 3213 which can be electrically coupled to the motherboard 310 via a bus, therefore the slave address (including the interface address SlotID and the device-type identification code CardID) comprised in the addressable element 321 can be transmitted to the CPU set on the motherboard 310 via the transmission bus 3213 and the bus. In this embodiment, the transmission bus 3213 may be an I²C transmission bus, and includes a data output terminal SDA and a clock output terminal SCLK. Of course, it is understandable for persons skilled in the art that, the transmission bus 3213 may also be a transmission bus with another type if the type of addressable elements 321 changes, and such that the transmission bus 3213 is electrically coupled to the motherboard 310 via a bus with another corresponding type, such as PCI bus or PCIE bus, and so on.

Therefore, in the electronic system 300 of the present disclosure, each of the slots 0˜n of the motherboard 310 is uniquely integrated with the interface address SlotID, rather than integrating the interface address in the addressable element 321 of the plug-in module 320. Therefore, when one plug-in module 320 is inserted into any one of the slots 0˜n of the motherboard 310, this slot can automatically assign the corresponding interface address SlotID to the addressable element 321 of the plug-in module 320 via the interface address line group 3211. Furthermore, when a slot needs to replace the plug-in module 320, it only need to replace another plug-in module 320 with the same type, the CPU set on the motherboard 310 can directly access the replaced plug-in module 320 according to the same interface address SlotID, and need not change any configuration of the software. The electronic system 300 of the present disclosure can arbitrarily replace the plug-in module 320 with the same type in the same slot, thereby enhancing the interoperability and maintainability of the plug-in module 320 with the same type, and extremely convenient in use.

In addition, the plug-in module 320 of the present disclosure adopts the addressable element 321 to integrate its corresponding device-type identification code for identifying the device type of the plug-in module 320. The addressable element 321 is electrically coupled to the bus via its own transmission bus 3213 for transmitting information. In this embodiment, the addressable element 321 may be an I²C addressable element, and can transmit the slave address (including the interface address SlotID and the device-type identification code CardID) to the CPU set on the motherboard 310 via its own I²C transmission bus (comprising the data output terminal SDA and the clock output terminal SCLK) and the corresponding I²C bus. Therefore, in the present disclosure, the plug-in module 320 need not add the extra EEPROM to store the device-type identification code thereof, thereby reducing the hardware cost. In addition, the present disclosure also need not set specific pins on the plug-in module 320 to provide the device-type identification code, and the present disclosure also need not additionally occupy the GPIO pins of the CPU.

In this embodiment, although the address lines A0˜Am of the addressable element 321 of each plug-in module 320 respectively using the pull-up resistor or the pull-down resistor, for example, being electrically coupled to the pull-up resistor or the pull-down resistor 3210 directly or being electrically coupled to the pull-up resistor or the pull-down resistor 3100 via the gold finger pins of the slots 0˜n of the motherboard 310, to obtain the logic high level or the logic low level respectively, thereby providing the device-type identification code CardID and the interface address SlotID. However, it is understandable for persons skilled in the art that, the address lines A0˜Am of the addressable element 321 of each plug-in module 320 can also be set to be in floating (e.g., floating ground), in order to obtain the logical floating ground level, thereby obtaining the interface address SlotID and the device-type identification code CardID.

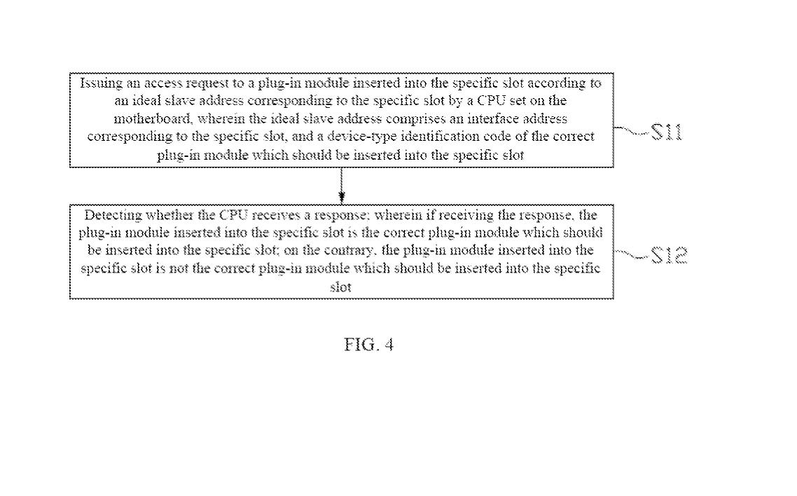

FIG. 4 is a flowchart of a judging method adapted to the electronic system 300 in accordance with an exemplary embodiment of the present disclosure. The judging method is for judging whether a correct plug-in module 320 is inserted into a specific slot [i] of the motherboard 310. Referring to FIG. 3 and FIG. 4 together, the judging method of the present disclosure includes step S11: issuing an access request to a plug-in module 320 inserted into the specific slot [i] according to an ideal slave address [i] corresponding to the specific slot [i] by the CPU set on the motherboard 310, wherein the ideal slave address [i] comprises an interface address SlotID [i] corresponding to the specific slot [i] and a correct device-type identification code IdealCardID [i] of the correct plug-in module which should be inserted into the specific slot [i]; and step S12: detecting whether the CPU receives a response from the transmission bus, wherein if receiving the response, the plug-in module 320 inserted into the specific slot [i] is the correct plug-in module which should be inserted into the specific slot [i]; on the contrary, the plug-in module 320 inserted into the specific slot slot[i] is not the correct plug-in module which should be inserted into the specific slot [i].

In detail, for the specific slot [i], the device type of the correct plug-in module which should be inserted into the specific slot [i] is predetermined. That is, even if no plug-in module is inserted into the specific slot [i], the correct device-type identification code IdealCardID [i] of the correct inserted plug-in module can be predetermined. Thus, the ideal slave address [i] of the specific slot slot[i] is as following:
Ideal slave address [i]=IdeaCardID [i]+SlotID [i];

When one plug-in module 320 is inserted into the specific slot [i], the plug-in module 320 has a real device-type identification code CardID [i], so the real slave address [i] is as following:
Real slave address [i]=CardID [i]+SlotID [i];

Therefore, when the real device-type identification code CardID [i] of the inserted plug-in module 320 is same to the correct device-type identification code IdealCardID [i], namely, Ideal slave address [i]=Real slave address [i], the CPU set on the motherboard 310 can uses the corresponding ideal slave address [i] of the specific slot [i] to issue the access request to the plug-in module 320 via the transmission bus. Then the plug-in module 320 responds the access request to return a response via the transmission bus, so that the CPU set on the motherboard 310 will receive the response from the transmission bus. Otherwise, the plug-in module 320 will not return the response, so that the CPU does not receive the response from the transmission bus. Therefore the judging method of this embodiment can accurately judge whether the correct plug-in module 320 is inserted into the specific slot [i].

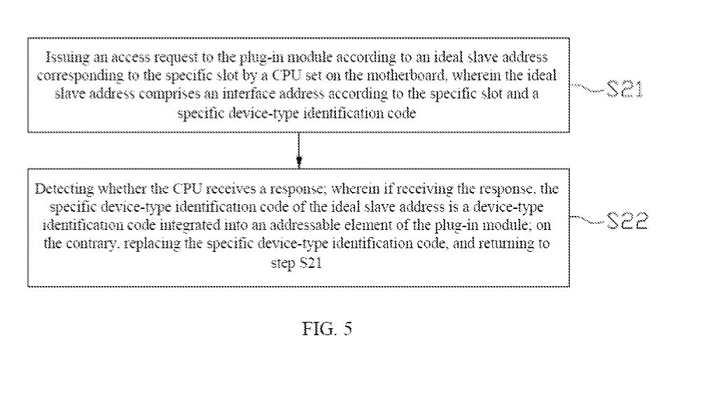

FIG. 5 is a flowchart of a querying method adapted to the electronic system 300 in accordance with an exemplary embodiment of the present disclosure. The querying method is for detecting a device-type identification code CardID [i] of one plug-in module 320 inserted into the specific slot [i] of the motherboard 310. Referring to FIG. 3 and FIG. 5 together, the above-mentioned querying method includes step S21: issuing an access request to the plug-in module 320 inserted into the specific slot [i] according to an ideal slave address [i] corresponding to specific slot [i] by the CPU set on the motherboard 310, wherein the ideal slave address [i] comprises an interface address SlotID [i] corresponding to the specific slot [i] and a specific device-type identification code DevTypeID [t]; and step S22: detecting whether the CPU set on the motherboard 310 receives a response; wherein if receiving the response, the specific device-type identification code DevTypeID [t] is the device-type identification code CardID [i] integrated in the addressable element 321 of the plug-in module 320; on the contrary, replacing the specific device-type identification code DevTypeID [t], that is to say, setting a next specific device-type identification code DevTypeID [t+1] as the specific device-type identification code DevCardID [t], and returning to step S21.

Therefore, the CPU set on the motherboard 310 can use a software program to execute the above-mentioned querying method. Codes of the above-mentioned software program are as follows:

```
For each t in {DevTypeIDs}
    {
      Ideal slave address = {DevTypeID [t], SlotID [i]}
    result = query ( ideal slave address );
    if ( result = = OK ), then
      the dev type on slot i is DevTypeID [t]
      return SUCCESS
    else
        continue
    endif
    }
return ERROR
```

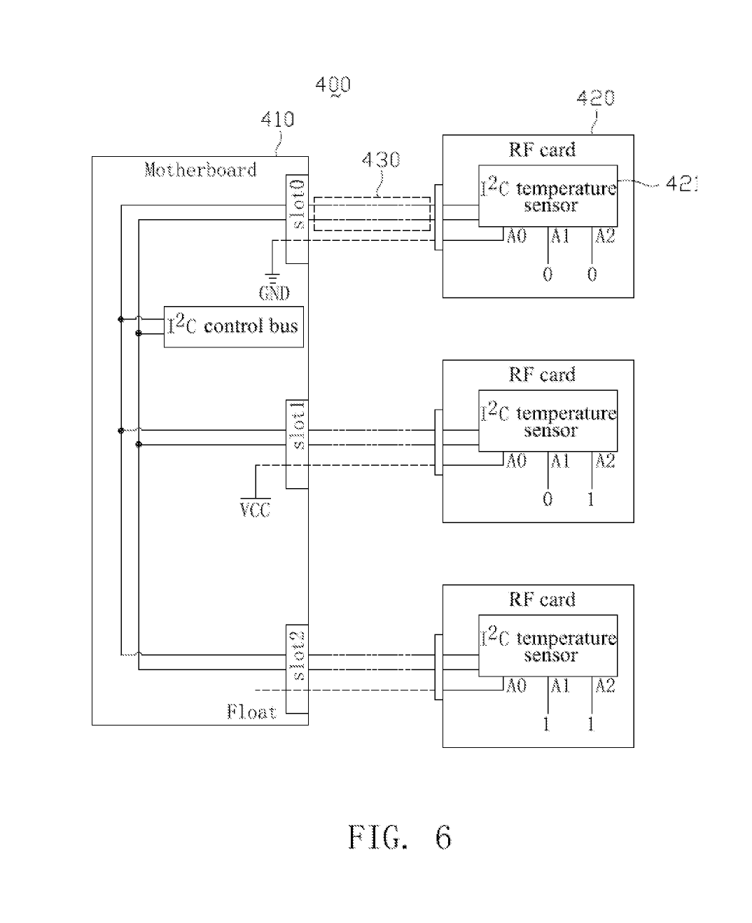

FIG. 6 is a schematic view of a detailed application of the electronic system in FIG. 3. Referring to FIG. 6, the motherboard 410 includes three slots, such as slot 0˜slot 2, which three plug-in modules 420 can be simultaneously inserted into. The slot 0˜slot 2 can be PCIE slots, the plug-in modules 420 can be radio-frequency (RF) cards, whose types are different with each other. A RF card 420 with the 2.4 G Low type should be inserted into the slot 0, a RF card 420 with the 2.4 G High type should be inserted into the slot 1, and a RF card 420 with the 5 G High type should be inserted into the slot 2.

Each of the RF cards 420 comprises an I²C temperature sensor 421 set thereon, as the addressable element, which has an slave address. The slave address of the I²C temperature sensor 421 includes an interface address SlotID and a device-type identification code CardID. The I²C temperature sensor 421 can be a TMP75 sensor, which includes three address lines A0˜A2, and each of the address lines can identify three different logic levels, such as, the logic high level, the logic low level, and the logic floating ground level. In addition, the address line A0 of the I²C temperature sensor 421 can be used to identify the interface address SlotID, and the address lines A1-A2 can be used to identify the device-type identification code CardID.

When the address line A0 is at the logic low level, it indicates that the RF card 420 is inserted into the slot 0; when the address line A0 is at the logic high level, it indicates that the RF card 420 is inserted into the slot 1; when the address line A0 is at the logic floating ground level, it indicates that the RF card 420 is inserted into the slot 2.

When the logic level combination of the address lines A1˜A2 is “00”, it indicates that the type of the RF card 420 is the 2.4 G Low type; when the logic level combination of the address lines A1˜A2 is “01”, it indicates that the type of the RF card 420 is the 2.4 G High type; when the logic level combination of the address lines A1˜A2 is “10”, it indicates that the type of the RF card 420 is the 5 G Low type; and when the logic level combination of the address lines A1˜A2 is “11”, it indicates that the of the RF card 420 is the 5 G High type.

Therefore, when the CPU set on the motherboard 410 detects whether a correct RF card (e.g., the RF card with the 2.4 G Low type) is inserted into a specific slot, such as the slot0, firstly, the CPU determines whether or not a RF card 420 is inserted into the specific slot0 via the PCIE transmission bus. Then the CPU uses the address “000” to access the I²C bus 430 according to the slave address binding principle. If receiving a response, it indicates that the RF card 420 inserted into the specific slot 0 is the correct RF card, that is, the RF card 420 inserted into the specific slot 0 is the RF card with the 2.4 G Low type. On the contrary, it indicates that the RF card 420 inserted into the specific slot 0 is not the correct RF card, that is, the RF card 420 inserted into the specific slot 0 is not the RF card with the 2.4 G Low type.

In addition, when the RF card 420 inserted into the specific slot 0 is not the correct RF card, the present invention can further query the device type of the RF card 420. For example, the CPU may further use the address “001” (which corresponds to the RF card with the 2.4 G High type) or “011” (which corresponds to the RF card with the 5 G High type), to detect whether the CPU receives the response, so as to easily determine what is the device type of the RF card 420 inserted into the specific slot 0.

In summary, the plug-in module and the electronic system of the present disclosure can use the addressable element of each of the plug-in module to define the slave address thereof. The slave address includes the interface address and the device-type identification code. In particular, when one plug-in module is inserted into one slot of the motherboard, the slot can automatically assign the corresponding interface address to the addressable element of the plug-in module via the interface address line group, therefore the interface address obtained by the addressable element always corresponds to the slot which the plug-in module is inserted into. The present disclosure can optionally change the plug-in module with the same type in the same slot, need not change the function of the software for accessing the slot, therefore the present disclosure greatly enhances interoperability and maintainability of the plug-in module with the same type, extremely convenient to use.

Furthermore, the plug-in module of the present disclosure may use the address lines of the addressable element to integrate the device-type identification code, thus indentifying the device type of the plug-in module, such that the plug-in module need not set the extra EEPROM to store the device-type identification code thereof, and also need not set special pins to integrate the device-type identification code, thus the present disclosure can reduce the hardware cost, and won't greatly occupy the resource of the GPIO pins of the CPU.

The above description is given by way of example, and not limitation. Given the above disclosure, one skilled in the art could devise variations that are within the scope and spirit of the disclosure disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A plug-in module, capable of being inserted into a slot of a motherboard pluggably, the plug-in module comprising:
an addressable element having a slave address, and the addressable element comprising:
an interface address line group, wherein when the plug-in module is inserted into the slot of the motherboard, the slot is able to automatically assign a corresponding interface address to the addressable element via the interface address line group; and
a device-type address line group, integrated with a device-type identification code to identify a device type of the plug-in module;
wherein the slave address comprises the interface address and the device-type identification code.

2. The plug-in module as claimed in claim 1, wherein the interface address line group of the addressable element comprises at least one address line, the slot of the motherboard comprises at least one gold finger pin, each gold finger pin is electrically coupled to a pull-up resistor, or a pull-down resistor, or is set to be in floating ground, respectively, to produce a logic high level, a logic low level, or a logical floating ground level, so as to identify the interface address of the slot, when the plug-in module is inserted into the slot of the motherboard, the at least one address line of the interface address line group of the addressable element is electrically coupled to the at least one gold finger pin of the slot, respectively, and thereby the slot is able to automatically assign the interface address to the addressable element via the interface address line group.

3. The plug-in module as claimed in claim 1, wherein the device-type address line group of the addressable element comprises at least one address line, each address line is electrically coupled to a pull-up resistor, or a pull-down resistor, or is set to be in floating ground, respectively, to produce a logic high level, a logic low level, or a logic floating ground level, thereby, the device type address line group is integrated with the device-type identification code to identify the device type of the plug-in module.

4. The plug-in module as claimed in claim 1, wherein the addressable element further comprises a transmission bus for outputting the slave address.

5. The plug-in module as claimed in claim 4, wherein the addressable element is an I²C addressable element, and the transmission bus is an I²C bus.

6. An electronic system comprising:
a motherboard, comprising at least one slot; and
at least one plug-in module, capable of be pluggably inserted into the at least one slot of the motherboard respectively, and each plug-in module comprising:
an addressable element having a slave address, and the addressable element comprising:
an interface address line group, wherein when the plug-in module is inserted into one slot of the motherboard, the slot is able to automatically assign a corresponding interface address to the addressable element via the interface address line group; and
a device-type address line group, integrated with a device-type identification code to identify a device type of the plug-in module;
wherein the slave address comprises the interface address and the device-type identification code.

7. The electronic system as claimed in claim 6, wherein the interface address line group of the addressable element of each plug-in module comprises at least one address line, the slot of the motherboard comprises at least one gold finger pin, each gold finger pin is electrically coupled to a pull-up resistor, or a pull-down resistor, or is set to be in floating ground, respectively, to produce a logic high level, a logic low level, or a logical floating ground level, so as to identify the interface address of the slot, when the plug-in module is inserted into the slot of the motherboard, the at least one address line of the interface address line group of the addressable element is electrically coupled to the at least one gold finger pin of the slot, respectively, and thereby the slot is able to automatically assign the interface address to the addressable element via the interface address line group.

8. The electronic system as claimed in claim 6, wherein the device type address line group of the addressable element of each plug-in module comprises at least one address line, each address line is electrically coupled to a pull-up resistor, or a pull-down resistor, or is set to be in floating ground, respectively, to produce a logic high level, a logic low level, or a logic floating ground level, thereby, the device type address line group is integrated with the device-type identification code to identify the device type of the plug-in module.

9. The electronic system as claimed in claim 6, wherein the addressable element of each plug-in module further comprises a transmission bus for outputting the slave address.

10. The electronic system as claimed in claim 9, wherein the addressable element of each plug-in module is an I²C addressable element, and the transmission bus is an I²C bus.

11. A judging method, adapted to an electronic system, for judging whether a correct plug-in module is inserted into a specific slot of a motherboard, and the judging method comprising:
step S11: issuing an access request to a plug-in module inserted into the specific slot according to an ideal slave address corresponding to the specific slot by a CPU set on the motherboard, wherein the ideal slave address comprises an interface address corresponding to the specific slot, and a device-type identification code of the correct plug-in module which should be inserted into the specific slot; and
step S12: detecting whether the CPU receives a response; wherein if the CPU receives the response, the plug-in module inserted into the specific slot is the correct plug-in module which should be inserted into the specific slot; on the contrary, the plug-in module inserted into the specific slot is not the correct plug-in module which should be inserted into the specific slot.

12. The judging method as claimed in claim 11, wherein when a device-type identification code of a slave address comprised in an addressable element of the plug-in module is same to the device-type identification code of the ideal slave address of the correct plug-in module which should be inserted into the slot, the plug-in module responds the access request, and the CPU receives the response.

13. The judging method as claimed in claim 11, wherein the CPU issues the access request to the plug-in module via a transmission bus, and the CPU receives the response via the transmission bus.
